(19) United States
(12) Patent Application Publication
(10) Pub. No.: US 2014/0266007 A1
(43) Pub. Date: Sep. 18, 2014

(54) Portable Charger

(71) Applicant: TELEDEX, INC., Kenilworth, NJ (US)

(72) Inventor: Ming Chun Li, Zhong Shan City (CN)

(73) Assignee: TELEDEX, INC., Kenilworth, NJ (US)

(21) Appl. No.: 13/826,514

(22) Filed: Mar. 14, 2013

(51) Int. Cl. H02J 7/00

(52) U.S. Cl. CPC H02J 7/0052; H02J 7/0042
USPC 320/107

(57) ABSTRACT

This new current invention will register a portable charger, especially the USB type one that uses lithium battery of 3.7 V as power source with output of some 5.2 V. It consists of outer case, circuit board within the outer case, USB port on the circuit board. One end of the outer case has a port for the compatible connection of USB port wire. Also installed on the outer case are the transfer part of active switch and passive switch. The passive switch is connected to the main circuit of the circuit board by means of switch. While the charger is not in use, the passive switch is off, and the main circuit is shut off in turn. And the internal battery has almost zero loss to save the energy at its maximum. Only when the charger is in use, some force is operated on the active switch, and the active switch will turn on the passive switch to have the main circuit connected for the consumption of the battery energy. Besides the maximum saving of electricity energy, this new current invention the function of dust-proof. So its prospective application is promising.

### CLAIM OF PRIORITY

This application claims no priority to any previous applications.

### FIELD OF THE INVENTION

The invention relates to the area of recharging technology, especially it refers to a new type of portable charger.

### BACKGROUND OF THE INVENTION

With economic development and the constant upgrading of science and technology, digital products such as mobile phones, PDA, MP4, iPhone have entered many people's daily lives. All these digital products have accessory rechargeable batteries for their operation power. However, most of the existing charging devices rely on the fixed power supply, converting alternating current to direct current for such recharging. Unfortunately, this is by no means a very convenient way of recharge in many cases such as field worksite or traveling when no electric outlet is accessible. Therefore, there is an evident need for a small or portable charger. Currently, some portable chargers do appear in the market, especially some USB type charger with 3.7V lithium battery as the supply and output power of 5.2V. Due to the fact that the voltage of the supply battery is different from that of output voltage, voltage boosting becomes necessary before the output request is met, leading naturally to loss of electricity during the boosting process. In addition, during the stand-by mode, the boosting circuit is on all the time and thus the loss of battery power is a plain waste of energy. So even without any load being connected, the battery would gradually go flat within a few weeks or even a few days, in which case, the supply battery has to be recharged first when emergency recharge to the digital devices is necessary because the recharger does not have enough power. The inconvenience and its related problems and defects lead to the need for innovation in the design of existing portable chargers.

In summary, some implements are known in the art, but fail to address all of the problems solved by the invention described herein. One embodiment of the current invention is illustrated in the accompanying drawings and will be described in more detail herein below.

### SUMMARY OF THE INVENTION

To solve the above-mentioned problems, this new current invention is offering a new portable charger that has almost zero loss of electricity in the stand-by state. The present invention discloses a portable charger, comprising: an outer case having a port opening and a converting component; a circuit board having a USB port, the circuit board installed within the outer case; the port opening of the outer case corresponds to the USB Slot, the control component has an active switch and a passive switch that is operated by active switch, the passive switch is switchably to a main circuit of the circuit board, when the charger is not in use, the passive switch is off, and the main circuit is shut off in turn; when the charger is in use, the active switch turns on the passive switch to have the main circuit connected.

As an optimization to the above design, the active switch has a dust cover, which can slide along at an end of the outer case with a power transfer component at the base of dust cover. There is a first chamfer at the power transfer component and a resetting element, one end of which is connected to the power transfer component and the other end to the inside wall of the outer case for the restoration of the dust cover position. When the charger is not in use the dust cover will cover the opening to close the connector of the USB port inside. When the charger is in use, the dust cover slides open to expose the connector of the USB port.

Furthermore, the passive switch may have a passive switch base, which has second chamfer that is coordinated to first chamfer. The second chamfer is movably fixed on the base.

In addition, the port opening may be placed on a top cap, which is attached to one end of the outer case. There is a sliding chute on the cap, with dust cover on one side of the cap. At the base of the dust cover, there is a slide bar that goes through the sliding chute to connect to the power transfer component on the other side of the cap.

Furthermore, the cap may have a hanging hole which has a hook fixed thereon.

Besides, the main circuit may include an input, a recharging control module, a light control module, a lithium battery and a boosting control module. One end of the input is connected to the recharging control module and the other is connected to the ground. The recharging control module and the light control module are respectively connected to the positive pole of the lithium battery, and the negative pole of the lithium battery is connected to the ground. The input end of boosting control module is connected to the positive pole of the lithium battery and its output end is connected to the USB port. The passive switch is fixed between the positive pole of the lithium battery and the input end of the boosting control module.

The advantages of the current invention include: As a new type of portable charger, it comprises the active switch and the passive switch that is operated by the active switch; the passive switch is connected to the main circuit of the circuit board; the active switch has a dust cover fixed at one end of the dust cover; when the recharge is needed, the dust cover is pushed open and the USB port is exposed and ready to be connected to the digital devices by its USB cord; at the same time, the passive switch within the charger is switched on, which turns on the internal circuit of the boosting control module and thus the circuit starts its recharging operation. On completion, while the digital device plug is pulled off, the dust cover springs back and shuts off the passive switch in turn. In this condition, the internal boosting circuit is shut off and stops working, so no battery energy is consumed and there is almost zero loss of electricity. In a word, only when the USB port is plugged in to the digital devices for recharging, can the battery energy be consumed. Besides the maximum save of energy, this new current invention is also dust-proof.

In general, the present invention succeeds in conferring the following, and others not mentioned, desirable and useful benefits and objectives.

It is an object of the present invention to provide a charger that is safe and easy to use.

It is another object of the present invention to provide a charger that is dust proof.

It is another object of the present invention to provide a charger that does not lose energy when the charger is not in use.

Yet another object of the present invention is to provide a charger that requires a minimum of maintenance.

It is another object of the present invention to provide a charger that is robust and durable.

Still another object of the present invention is to provide a charger that is inexpensive.

Yet another object of the present invention is to provide a charger that is light and easy to carry around.

Still another object of the present invention is to provide chargers having different sizes and dimensions to fit the needs for different users and different uses.

Yet another object of the present invention is to provide a charger that is compact in size and easy to store and pack.

It is a further object of the invention to provide a charger that is easy to manufacture.

### BRIEF DESCRIPTION OF THE DRAWINGS

FIG. 1 is an exploded view of a preferred embodiment of the current invention, showing all the elements.

FIG. 2 is a partially separated view of the preferred embodiment of the current invention, shown some of the elements.

FIG. 3 is another partially separated view of the preferred embodiment of the current invention, shown some of the elements.

FIG. 4 is a perspective view of the preferred embodiment, showing the charger when the dust cover slides open for the switch-on of the main circuit;

FIG. 5 is a perspective view of the preferred embodiment, showing the charger when the dust cover is closed for the switch-off of the main circuit;

FIG. 6 is the sketch of the main circuit of the new current invention.

### DESCRIPTION OF THE PREFERRED EMBODIMENTS

The preferred embodiments of the present invention will now be described with reference to the drawings. Identical elements in the various figures are identified, as far as possible, with the same reference numerals. Such embodiments are provided by way of explanation of the present invention, which is not intended to be limited thereto. In fact, those of ordinary skill in the art may appreciate upon reading the present specification and viewing the present drawings that various modifications and variations can be made thereto without deviating from the innovative concepts of the invention.

Referring to FIGS. 1-6, the new portable charger comprises outer case 1, within which installed is circuit board 2, which is connected to a USB Port 3. At one end of the outer case 1 there is port opening 11 compatible to a connecting wire to USB port 3. Connected to the outer case 1, there is a control component which contains an active switch 4 and a passive switch 5 that is operated by active switch 4. This passive switch 5 is switchably connected to the main circuit of the circuit board 2 and controls the on/off of the main circuit. When the charger is not in use, the passive switch 5 is off, and the main circuit is shut off in turn; when the charger is in use, some force is exerted on the active switch 4, and the active switch 4 will turn on passive switch 5 to have the main circuit connected.

Still referring to FIGS. 1-6, the active switch 4 has a dust cover 41, which can slide along at a top end of the outer case 1. A power transfer component 42 is fixed at the base of the dust cover 41. There is a first chamfer 43 at power transfer component 42 and a resetting element 44. One end of the resetting element 44 is connected to the power transfer component 42 and the other end is connected to the inside wall of the outer case 1 for the restoration of the dust cover 41 position. When the charger is not in use, dust cover 41 will cover Port 11 closing the connector of USB Port 3 inside. When the charger is in use, dust cover 41 slides open to expose the connector of USB Port 3. The connection to the external digital devices is achieved by wiring the USB plug, at the same time, the internal passive switch 5 within the circuit is switched simultaneously. The passive switch 5 turns on the circuit and thus the circuit starts its recharging operation. On completion, while digital device plug is pulled off, the dust cover 41 springs back and shuts off the passive switch 5 in turn, the internal boosting circuit is thus forced off and close to zero loss of electricity is achieved.

The passive switch 5 has Passive switch base 51, which has a second chamfer 52 that is coordinated to first chamfer 43. The second chamfer 52 is movably fixed on the passive switch base 51. The second chamfer 52 may turn up and down at the bottom corner of passive switch base 51. When the charger is not in use, the second chamfer 52 springs up turning off the passive switch 5 and the main circuit is shut off. When the charger is in use, the dust cover 4 slides open and makes the first chamfer 43 to open too. The first chamfer 43 turns the second chamfer 52 down around its bottom corner, thus the passive switch 5 is turned on and the main circuit is connected.

One end of the outer case 1 has top cap 6, set on which is port opening 11. There is sliding chute 61 on top cap 6, with dust cover 41 on one side of the top cap 6. At the base of the dust cover 41, there is a slide bar 45 that goes through sliding chute 61 to connect to the power transfer component 42 on the other side of the top cap 6.

The top cap 6 has a hanging hole 62 which has a hook 63 fixed thereon. The hook 63 makes it more convenient for the charger to be carried around.

Referring to FIG. 6, the main circuit comprises an Input 71, a Recharging Control Module 72, a Light Control Module 73, a Lithium Battery 74 and a Boosting Control Module 75. One end of the Input 71 is connected to the Recharging Control Module 72 and the other is connected to the ground. The Recharging Control Module 72 and the Light Control Module 73 are respectively connected to the positive pole of the Lithium Battery 74, and the negative pole of the Lithium Battery 74 is connected to the ground. The input end of the Boosting Control Module 75 is connected to the positive pole of the Lithium Battery 74 and its output end is connected to USB Port 3. The passive switch 5 is fixed between the positive pole of the Lithium Battery 74 and the input end of the Boosting Control Module 75.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A portable charger, comprising:
an outer case having a port opening and a converting component;
a circuit board having a USB port, the circuit board installed within the outer case;
the port opening of the outer case corresponds to the USB Slot,
the control component has an active switch and a passive switch that is operated by active switch,
the passive switch is switchably connected to a main circuit of the circuit board,
when the charger is not in use, the passive switch is off, and the main circuit is shut off in turn;
when the charger is in use, the active switch turns on the passive switch to have the main circuit connected.

2. The portable charger of claim 1, further comprising a resetting element, wherein
the active switch includes a dust cover slidably installed on a top end of the outer case,
a power transfer component is installed at a dust cover base of the dust cover,
the transfer component has a first chamfer,
the resetting element has a first end and a second end,
the first end of the resetting element is connected to the power transfer component, and
the second end of the resetting element is connected to an inside surface of the outer case,
the resetting element is capable of restoring the dust cover to an original position, when the charger is not in use the dust cover shields the port opening, enclosing the USB Port inside, and
when the charger is in use, the dust cover slides open to expose the USB Port.

3. The portable charger of claim 2, wherein
the passive switch has a passive switch base,
there is a second chamfer corresponding to the first chamfer, and
the second chamfer is movably fixed on the passive switch base.

4. The portable charger of claim 2, wherein
there is a top cap installed on a top end of the outer case,
the top cap has a sliding chute,
the dust cover includes a slide bar underneath the dust cover,
the power transfer component is disposed in the top cap 6, and
the slide bare goes through the sliding chute to connected to the power transfer component.

5. The portable charger of claim 3, wherein
there is a top cap installed on a top end of the outer case,
the top cap has a sliding chute,
the dust cover includes a slide bar underneath the dust cover,
the power transfer component is disposed in the top cap 6, and
the slide bare goes through the sliding chute to connected to the power transfer component.

6. The portable charger of claim 5, wherein
there is a hanging hole on the top cap,
and a hook attaches to the hanging hole.

7. The portable charger of claim 1, wherein
the main circuit comprises of an input, a recharging control module, a light control module, a battery, and a boosting control module,
the input is connected to the recharging control module and to the ground,
the recharging control module and the light control module are respectively connected to a positive pole of the battery,
the negative pole of battery is connected to the ground,
an input end of boosting control module is connected to the positive pole of battery and its output end is connected to the USB port,
and the passive switch is fixed between the positive pole of the battery and the input end of the boosting control module.
